(19) United States
(12) Patent Application Publication
(10) Pub. No.: US 2012/0042478 A1
(43) Pub. Date: Feb. 23, 2012

(54) Adjustable Handle

(76) Inventor: Kelly Daniel Bridges, Abington, MA (US)

(21) Appl. No.: 12/858,076

(22) Filed: Aug. 17, 2010

(51) Int. Cl. B25G 1/10

(52) U.S. Cl. 16/430

(57) ABSTRACT

An adjustable handle for a personal care implement including an elongated structure having a length that extends from a proximal end to a distal end. The elongated structure has a pliable material such that the pliable material is adapted to bend at about 25° C. from an initial fixed position to an alternate fixed position in response to a pressure applied to the elongated structure.

### BACKGROUND OF THE INVENTION

Handles of personal care devices are typically limited ergonomically thereby forcing the user to hold the device in a particular fashion that may be uncomfortable. There have been several attempts at creating an adjustable handle or a material for a handle that is adjustable. For example, U.S. Pat. Pub. No. 2004/0177518 describes a razor cartridge assembly having a flexible handle that may be bent by applying pressure to the handle. After removing the pressure, the flexible handle returns to its original state. U.S. Pat. No. 5,771,591 discloses a flexible, resilient, reduced diameter area connecting the handle to the razor head retains the handle and razor head in a normal position until a force is applied.

There have also been several attempts to provide handles which can be deformed when subjected to elevated temperatures, such as by applied heat or hot water. U.S. Pat. No. 4,829,621 describes an adjustable toothbrush that is deformable upon applying heat or hot water. U.S. Pat. No. 5,850,659 describes a toothbrush with a bendable head. The toothbrush head is connected at a fixed rotation point at the top of the handle such that the head is rotatable and bendable about that fixed rotation point. U.K. Pat. No. 304,459 describes a toothbrush handle having a perforated metal or wire mesh sandwiched between two sheets of celluloid material. The material is deformable above normal temperatures and below that of boiling water. However, distortion is prevented at the softening temperature of the celluloid. U.S. Pat. No. 4,227,276 discloses yet another type of toothbrush handle formed of a thermoplastic material with a glass transition temperature in the range of about 110°-140° F. This handle is heated to soften the plastic shaped to a desired configuration while pliable, then allowed to cool so as to retain the desired configuration when it hardens.

Despite these and other types of handles, there is a need for a new handle which can be adjusted into different bent shapes without flexing back to an at rest position, without the need for elevated temperatures. This would allow users the ability to adjust a handle to a desired arrangement which is maintained until the user deems a new arrangement is more preferable without the need to heat the handle.

### SUMMARY OF THE INVENTION

In an aspect, the invention features an adjustable handle for a personal care implement. The adjustable handle comprises an elongated structure having a length that extends from a proximal end to a distal end and a pliable material that is adapted to bend at about 25° C., i.e., room temperature, from an initial fixed position to an alternate fixed position in response to a pressure being applied.

Another implementation features a method of using an adjustable handle for a personal care implement. The method includes: (a) providing an elongated structure having a length that extends from a proximal end to a distal end, the elongated structure comprising a pliable material adapted to bending at about 25° C., and (b) bending the elongated structure from an initial position to an alternate position. Without intending to be bound by theory, it is believed that by selecting materials which do not require heat to deform, the present handle can be adjusted quickly and easily without requiring a source of heat to be available. This can be particularly useful in situations where heat or hot water are not available but the user still wants to adjust the arrangement or bend their handle. Also by selecting materials which do not automatically flex back into a resting position, the user can select an adjusted position and the handle will maintain that position for as long as needed. The user can thereafter easily readjust back to the normal position, or to another adjusted position, without the need to obtain a source of heat.

Certain implementations of the invention may include one or more of the following features. The personal care implement may have a functional member joined to the handle, such as a razor cartridge assembly, a toothbrush head, a brush head, or a comb. An insert may be disposed in the elongated structure such that the insert is made of a semi-rigid material. The pliable material and/or the semi-rigid material may be selected from the group consisting of a metal, a metal alloy, a shape memory polymer, an elastomeric material, a thermoplastic material, a thermoplastic elastomer, a thermoset elastomer, a polyurethane material, a polysiloxane material, derivatives and combinations thereof. In another implementation, the handle may be bent to other various fixed positions.

Other features and advantages of the invention will be apparent from the description and drawings, and from the claims.

### BRIEF DESCRIPTION OF THE DRAWINGS

FIG. 1 is a perspective view of an adjustable handle for a personal care implement in an initial fixed position;

FIG. 2 is a perspective view of an adjustable handle in accordance with the present invention;

FIG. 3 is another perspective view of an adjustable handle in accordance with the present invention wherein the handle is in an alternate fixed position.

FIG. 4 is a perspective view of another adjustable handle in accordance with the present invention;

FIG. 5 is a perspective view of another adjustable handle in accordance with the present invention;

FIG. 6 is a perspective view of another adjustable handle in accordance with the present invention;

FIG. 7 is a perspective view of another adjustable handle in accordance with the present invention; and

FIG. 8 is a perspective view of yet another adjustable handle in accordance with the present invention.

### DETAILED DESCRIPTION OF THE INVENTION

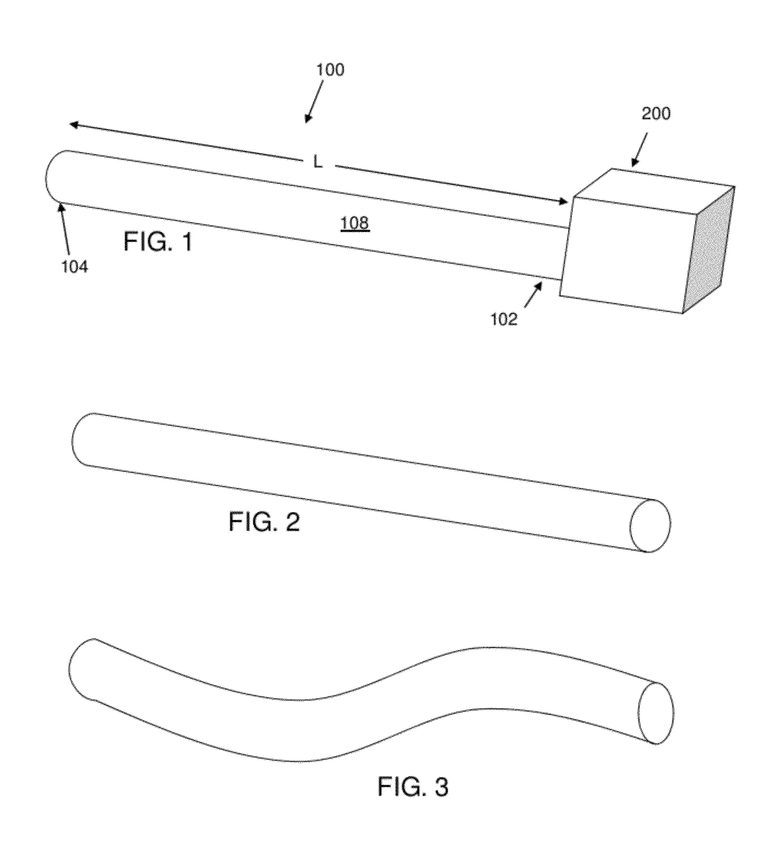

FIG. 1 shows an adjustable handle (100) for a personal care implement having head (200). The head can be removable or can be permanently attached to said adjustable handle. FIG. 2 shows a similar adjustable handle without the head. The adjustable handle has a length (L) that extends from a proximal end (102) to a distal end (104). The adjustable handle comprises a pliable material (108) such that the pliable material is adapted to bend about 25° C. from an initial fixed position, shown in FIG. 1, to an alternate fixed position, such as shown in FIG. 3 in response to a pressure being applied to a portion of the adjustable handle. The adjustable handle can also be adapted into other fixed positions based on user preference.

Many types of pliable materials could be utilized, such as a metal, a metal alloy, a shape memory polymer, an elastomeric material, a thermoplastic material, a thermoplastic elastomer, a thermoset elastomer, a polyurethane material, a polysiloxane material, derivatives and combinations thereof. In one embodiment, the pliable material may be formed of a thermoset elastomer, e.g., F-42 A/B by BJB Enterprises, Inc., or a thermoplastic elastomer, e.g., Kraton, having a 20-50 shore A durometer, MONPRENE® (sold by QST, Inc. of St. Albans, Vt.), SANTOPRENE® (exclusively licensed to Advanced Elastomer Systems, L.P. of Akron, Ohio), or DYNAFLEX™ (sold by GLS Corporation of McHenry, Ill.).

In one embodiment, the pliable material is selected from a material having a Young's modulus from about 70 to about 15,000 PSI at atmospheric pressure of 1 ATM and 25° C., or from about 70 PSI to about 240 PSI. In another embodiment, the pliable material has an elongation at break of from about 100% to about 1,000%, or from about 120% to about 860%.

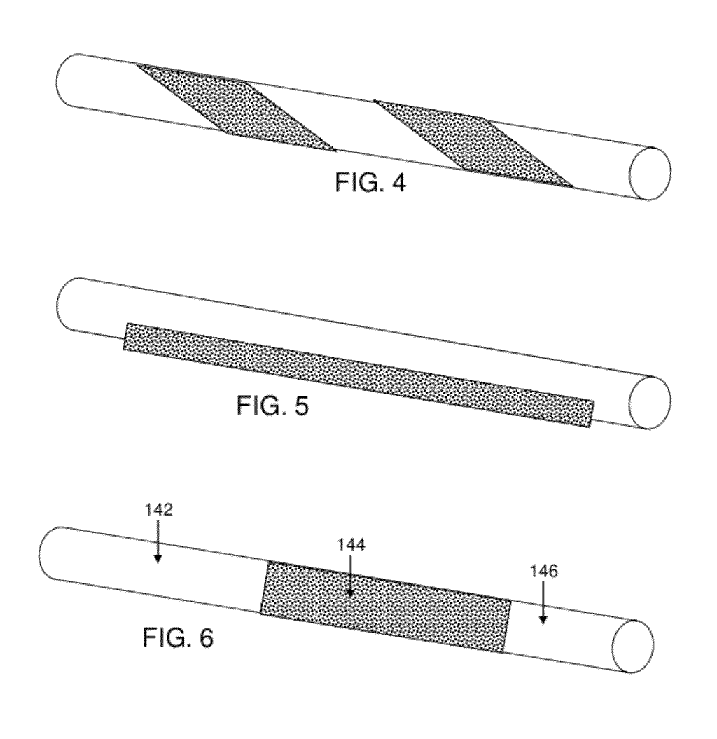

In one embodiment, the handle is formed from more than one pliable material, the pliable materials can be in a composition, or they can be in discrete layers. In one embodiment, the handle comprises more than one pliable material where the pliable materials are in discrete layers extending across the length of the handle (for example an inner layer and an outer layer or two or more adjacent materials side by side), or form different layers extending across the width of the handle (for example a distal layer, a middle layer, and a proximal layer). FIGS. 4 and 5 provide examples of a handle comprising at least two pliable materials extending across the length of the handle. Those of skill in the art will understand that the different configurations can be selected based on the specific properties of the materials and the desires of the intended user. For example, certain users may prefer the striping shown in FIG. 4, while others may prefer the handle to be more linear in design as shown in FIG. 5. FIG. 6 provides an example of an adjustable handle having more than one component, wherein at least one of said components comprises a pliable material. In this example the adjustable handle comprises a distal component (142), a middle component (144) and a proximate component (146). At least one of said components comprises a pliable material and in this case the middle component is shown of pliable material. Where multiple layers are provided, the layers can be made of the same pliable material or composite of pliable materials, or can be different.

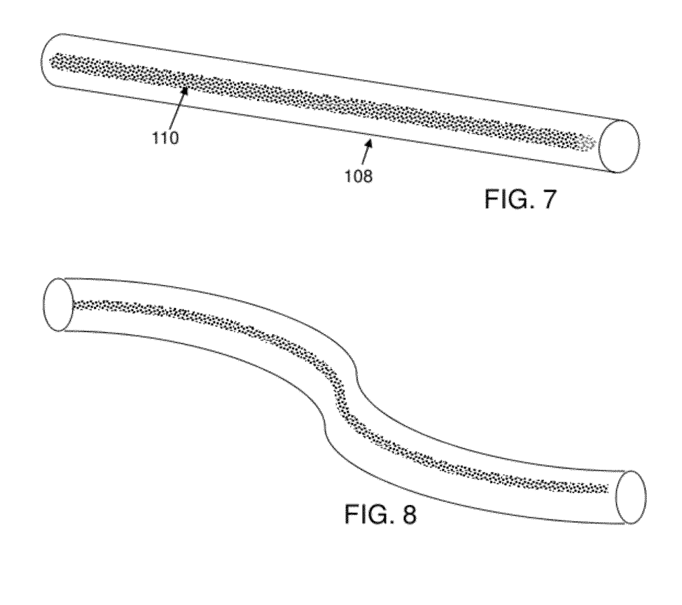

To help ensure the adjustable handle (100) remains in a fixed position, an insert (110) may be disposed therein, as shown in FIGS. 7-8. The insert (110) is typically formed of a semi-rigid material (118) such as a metal, a metal alloy, a shape memory polymer, an elastomeric material, a thermoplastic material, a thermoplastic elastomer, a thermoset elastomer, a polyurethane material, a polysiloxane material, derivatives and combinations thereof. Other suitable semi-rigid materials could likewise be used. Additionally, the insert can be made of a second pliable material which can have a higher Young's modulus than the pliable material used to make the portion of the adjustable handle at least partially encasing the insert. Additionally, the insert (110) may have several interconnected joints or linkages, e.g., balls and sockets, allowing the bending at each connection.

The handle (100) may be formed or shaped by a user to enhance comfort and/or grip by utilizing various features on the surface of the handle (100). For example, the surface of the handle (100) may have grooves, recessed or elevated patterns, such as dimples, ribs, bumps, or a lattice or a honeycomb pattern. Additionally, the surface of the handle (100) may be textured, roughened, or otherwise to increase the desired effect. These features may extend along the entire length (L) of the handle (100) or only a portion thereof.

The head (200) can be a razor cartridge assembly, a trimmer blade assembly, a toothbrush head, a brush head, or a comb. The personal care implement may be constructed by insert or injection molding processes so that the handle and the functional member may be formed separately or as a unitary assembly. The razor cartridge assembly may be of the type disclosed in U.S. Pat. No. 5,787,586, which generally describes a type of design commercialized as Mach 3 by The Gillette Company, or U.S. Pat. No. 7,197,825, which generally describes a type of design commercialized as Fusion by The Gillette Company.

The invention also encompasses a method of using an adjustable handle for a personal care implement as described herein. The method includes providing an elongated structure, as described above, and bending the elongated structure from an initial fixed position to an alternate position. Additional, the elongated structure may be further bent into additional fixed positions.

The invention is not limited to those materials of construction described herein, and anticipates that a number of materials may be used to accomplish the characteristics of the handle. The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, are hereby incorporated herein by reference in its entirety unless expressly excluded or otherwise limited. The citation of any document is not an admission that is prior art with respect to any invention disclosed or claimed herein or that is alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications may be made without departing from the spirit and scope of the invention. It is therefore intended to cover in the appended claims all such changes and modifications that are within the scope of this invention.

What is claimed is:

1. An adjustable handle for a personal care implement comprising an elongated structure having a length that extends from a proximal end to a distal end, the elongated structure comprising a pliable material adapted to bend at about 25° C. from an initial fixed position to an alternate fixed position in response to a pressure applied to the elongated structure.

2. The handle of claim 1, wherein the pliable material is selected from the group consisting of a metal, a metal alloy, a shape memory polymer, an elastomeric material, a thermoplastic material, a thermoplastic elastomer, a thermoset elastomer, a polyurethane material, a polysiloxane material, derivatives and combinations thereof.

3. The handle of claim 1, wherein the elongated structure further comprises an insert disposed within the elongated structure, wherein the insert comprises a semi-rigid material.

4. The handle of claim 3, wherein the semi-rigid material is selected from the group consisting of a metal, a metal alloy, a shape memory polymer, an elastomeric material, a thermoplastic material, a thermoplastic elastomer, a thermoset elastomer, a polyurethane material, a polysiloxane material, derivatives and combinations thereof.

5. The handle of claim 1, wherein the elongated structure is configured to be bent to various fixed positions.

6. The handle of claim 1, wherein the handle is joined to a functional member that is selected from the group consisting of a razor cartridge assembly, a toothbrush head, a brush head, and combinations thereof.

7. An adjustable handle for a personal care implement comprising an elongated structure having a length that extends from a proximal end to a distal end, the elongated structure comprising a pliable material and having an insert comprising a semi-rigid material disposed in the pliable material, wherein the elongated structure is adapted to bend at about 25° C. from an initial fixed position to an alternate fixed position in response to a pressure applied to the elongated structure.

8. The handle of claim 7, wherein the pliable material is selected from the group consisting of a metal, a metal alloy, a shape memory polymer, an elastomeric material, a thermoplastic material, a thermoplastic elastomer, a thermoset elastomer, a polyurethane material, a polysiloxane material, derivatives and combinations thereof.

9. The handle of claim 7, wherein the semi-rigid material is selected from the group consisting of a metal, a metal alloy, a shape memory polymer, an elastomeric material, a thermoplastic material, a thermoplastic elastomer, a thermoset elastomer, a polyurethane material, a polysiloxane material, derivatives and combinations thereof.

10. The handle of claim 7, wherein the handle is joined to a functional member that is selected from the group consisting of a razor cartridge assembly, a toothbrush head, a brush head, and combinations thereof.

11. A method of using an adjustable handle for a personal care implement comprising:
(a) providing an elongated structure having a length that extends from a proximal end to a distal end, the elongated structure formed of a pliable material adapted to bending at about 25° C.; and
(b) bending the elongated structure from an initial fixed position to an alternate fixed position.

12. The method of claim 11, wherein the pliable material is selected from the group consisting of a metal, a metal alloy, a shape memory polymer, an elastomeric material, a thermoplastic material, a thermoplastic elastomer, a thermoset elastomer, a polyurethane material, a polysiloxane material, derivatives and combinations thereof.

13. The method of claim 11, wherein the elongated structure further comprises an insert disposed therein, wherein the insert comprises a semi-rigid material.

14. The handle of claim 11, wherein the semi-rigid material is selected from the group consisting of a metal, a metal alloy, a shape memory polymer, an elastomeric material, a thermoplastic material, a thermoplastic elastomer, a thermoset elastomer, a polyurethane material, a polysiloxane material, derivatives and combinations thereof.

15. The method of claim 11, further comprising step (c) bending the elongated structure to an additional fixed position.

16. The method of claim 11, wherein the handle is joined to a functional member that is selected from the group consisting of a razor cartridge assembly, a toothbrush head, a brush head, and combinations thereof.
